(19) United States
(12) Patent Application Publication
(10) Pub. No.: US 2009/0179466 A1
(43) Pub. Date: Jul. 16, 2009

(54) Adjustable bicycle seat securing device

(76) Inventor: Rick Tsai, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,599

(22) Filed: Jan. 14, 2008

(51) Int. Cl. B62J 1/00

(52) U.S. Cl. 297/201

(57) ABSTRACT

A bicycle seat securing device includes a clamping unit connected to a seat stem and the clamping unit includes a left clamp and a right clamp. The seat stem is located between the left clamp and the right clamp. The left clamp and the right clamp are moved linearly in the radial direction of the seat stem so as to clamp rails of the seat. A bolt extends through the clamping unit and the seat stem and the clamping unit can be pivotable about the bolt to adjust the seat.

### FIELD OF THE INVENTION

The present invention relates to an adjustable bicycle seat securing device which includes two clamps movable relative to the seat stem and the rails under the seat are clamped between the two clamps.

### BACKGROUND OF THE INVENTION

A conventional bicycle seat securing device 80 is shown in FIGS. 14 and 15, and generally includes a top clamp 84 and a bottom clamp 85, the top and bottom clamps 84 and 85 are located between the seat 81 and the seat stem 82. The bottom clamp 85 is connected to the seat stem 82 and two bolts 86 extend through the bottom clamp 85 and the top clamp 84 so as to clamp two rails 83 connected to an underside of the seat 81. Because the top and bottom clamps 84 and 85 are located between the seat 81 and the seat stem 82, and the two bolts 86 have to connect the two clamps 84, 85 from the underside of the seat 81, so that it is difficult for the assembler to assemble the seat to the seat stem 82. Special tools are needed to complete the assembling actions.

Another conventional bicycle seat securing device is shown in FIGS. 16 and 17, and generally includes a support member 92 connected on the top of the seat stem 91 and two inclined surfaces 93 are defined in a lower edge of each of the two sides of the support member 92. A first clamp unit 94 includes two clamps 941, 942 which are located on the two sides of the support member 92 and each have a tapered surface 943 so as to be slidably engaged with the inclined surfaces 93 on the two sides of the support member 92. A bolt extends through two respective holes 944 of the two clamps 941, 942 so as to securely connect the two clamps 941, 942 to the support member 92. Each of the two clamps 941, 942 includes a top hook portion 945. A second clamp unit 95 including two top members 951, 952 which are connected with the two clamps 941, 942 respectively and each include two grooves 953 in a top thereof, the top hook portions 945 are cooperated with the grooves 953 of the two top members 951, 952 such that the rails of the seat are clamped in the space between the grooves 953 and the top hook portions 945. Nevertheless, this bicycle seat securing device requires too many parts which are easily separated and drop on the floor when assembling, especially for the two top members 951, 952 which lack proper positioning structure during assembling.

The present invention intends to provide a bicycle seat securing device wherein the parts of the device are well positioned during assembling and the two clamps are slidably engaged to each other, and this significantly improves the shortcoming of the conventional bicycle seat securing devices.

### SUMMARY OF THE INVENTION

The present invention relates to a bicycle seat securing device includes a clamping unit connected to a seat stem and the clamping unit includes a left clamp and a right clamp. The seat stem is located between the left clamp and the right clamp. The left clamp and the right clamp are moved linearly in the radial direction of the seat stem so as to clamp rails of the seat. A bolt extends through the clamping unit and the seat stem and the clamping unit can be pivotable about the bolt to adjust the seat.

The primary object of the present invention is to provide a bicycle seat securing device which requires less number of parts and the two clamps are slidably connected to each other in radial direction of the seat stem.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the securing device securing a bicycle seat of the present invention;

FIG. 2 is an exploded view to show the securing device of the present invention;

FIG. 3 is a partial cross sectional view to show the securing device of the present invention;

FIG. 4 shows that the bolt is to be connected to the securing device of the present invention;

FIG. 5 shows that the two clamps are moved toward each other by tightening the bolt;

FIGS. 6 and 7 show that the seat is pivotable about the bolt;

FIG. 8 is an exploded view to show the second embodiment of the securing device of the present invention;

FIG. 9 is an exploded view to show the third embodiment of the securing device of the present invention;

FIG. 10 is a partial cross sectional view to show the securing device of the present invention in FIG. 9;

FIG. 11 is a perspective view to show the securing device of the present invention in FIG. 9;

FIG. 12 is a perspective view to show that the two clamps of the securing device of the present invention in FIG. 9 are separated from each other;

FIG. 13 is a top view to show that the two clamps of the securing device of the present invention in FIG. 9 are separated from each other;

FIG. 14 is a perspective view to show a conventional bicycle seat securing device;

FIG. 15 is a side view to show the conventional bicycle seat securing device in FIG. 14 securing a bicycle seat;

FIG. 16 is a perspective view to show another conventional bicycle seat securing device, and

FIG. 17 is an exploded view to show the conventional bicycle seat securing device in FIG. 16.

### DETAILED DESCRIPTION OF THE PREFERRED EMBODIMENT

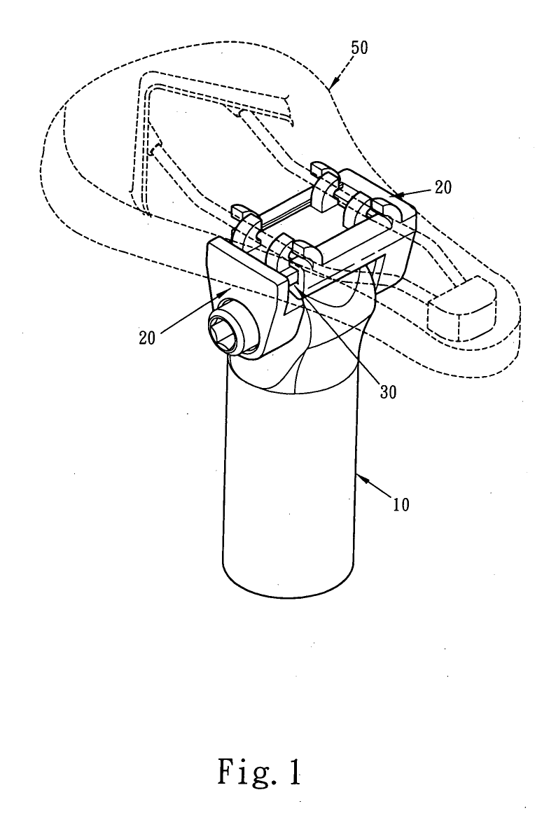

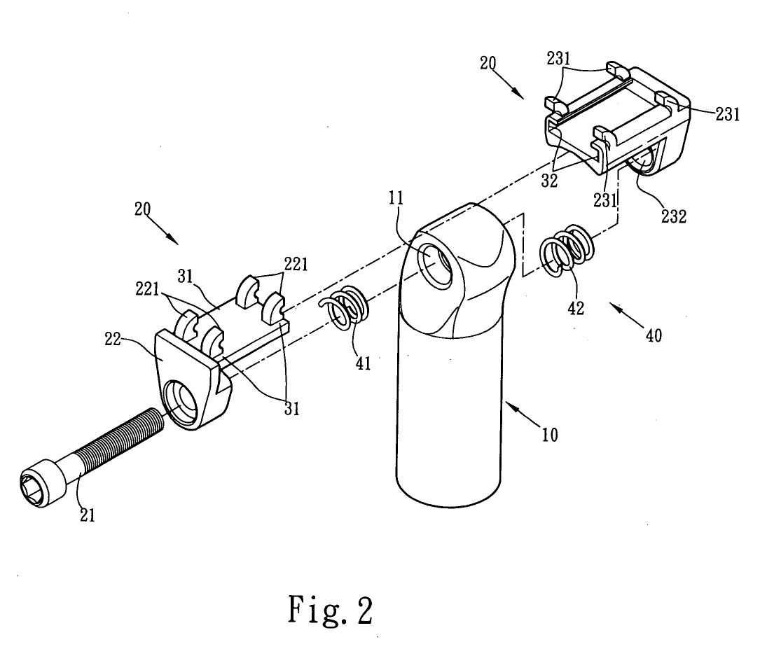

Referring to FIGS. 1 to 5, the bicycle seat securing device of the present invention comprises a clamp unit 20 connected to a seat stem 10 in radial direction and the clamp unit 20 includes a left clamp 22 and a right clamp 23, wherein a head portion of the seat stem 10 is located between the left clamp 22 and the right clamp 23. The left clamp 22 and the right clamp 23 are moved linearly in the radial direction of the seat stem 10 to clamp the rails of the seat 50 as shown in FIG. 1.

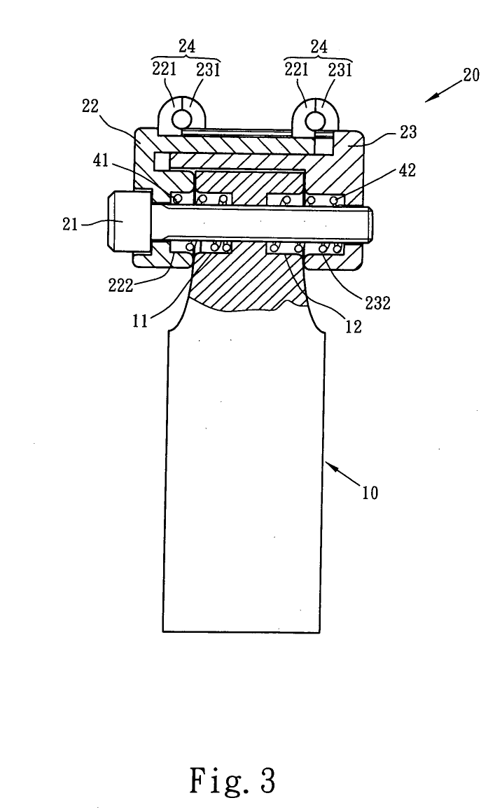

The left clamp 22 includes a body with a hole defined therethrough and a rectangular board extends perpendicularly from the body and in the radial direction mentioned above. A left clamping portion 221 extend from a top of the rectangular board and are four curved hooks. The right clamp 23 includes a body with a hole defined therethrough and a rectangular board extends perpendicularly from the body and in the radial direction mentioned above. A right clamping portion 231 extend from a top of the rectangular board and are four curved hooks which face the four curved hooks of the left clamping portion 221. The rectangular board of the left clamp 22 is sized to be located on the rectangular board of the right clamp 23 and the four curved hooks of the right clamp 23 are located on outsides of the curved hooks of the left clamp 22. In other words, the left clamping portion 221 and the right clamp 23 are located along parallel radial planes. The curved hooks of the left portion 221 are cooperated with the curved hooks of the right clamping portion 231 to form four clamp spaces 24 (FIG. 3) to clamp the rails of the seat 50.

An engaging unit 30 is located between the left and right clamps 22, 23 so as to guide the left and right clamps 22, 23 to move relative each other in the radial direction of the seat stem 10. The engaging unit 30 includes a first engaging portion connected to the left clamp 22 and a second engaging portion is connected on the right clamp 23, the first engaging portion is slidably connected with second engaging portion. The first engaging portion includes two flanges 31 on two sides of the rectangular board of the left clamp 22 and the second engaging portion includes two grooves 32 defined in the rectangular board of the right clamp 23. The flanges 31 extend perpendicularly to the radial direction of the seat stem 10 and are slidably engaged with the grooves 32.

A spring unit 40 includes two springs 41, 42, one of the springs is connected between the left clamp 22, the seat stem 10 and the other spring is connected between right clamp 23 and the seat stem 10. The seat stem 10 includes two first recesses 11, 12 in two sides of the head portion thereof and the first and second clamps 22,23 have two second recess 222, 232 respectively. The two ends of the spring 41 are respectively engaged with the first and second recesses 11, 231, and the two ends of the spring 42 are respectively engaged with the first and second recesses 12, 232.

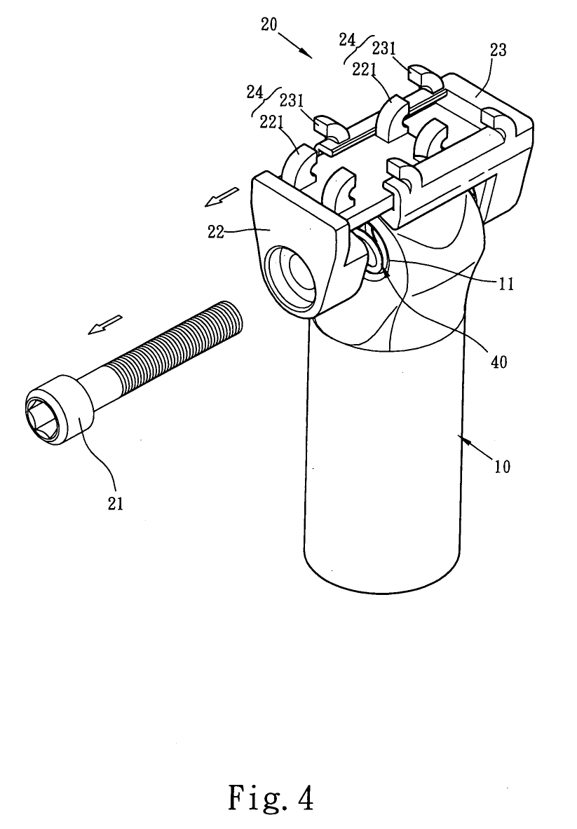

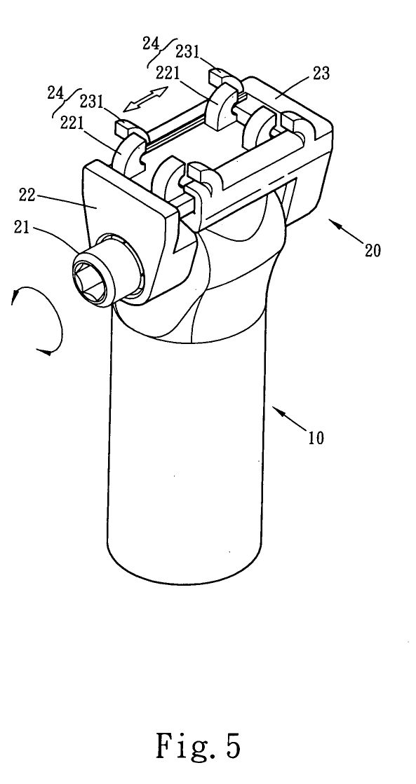

A bolt 21 threadedly extends through the hole in the left clamp 22, the spring 41, the head portion of the seat stem 10, the spring 42 and the hole in the right clamp 23. When loosening the bolt 21, the left and right clamps 22, 23 are moved away from each other, the left and right clamping portions 221, 231 are in un-clamp status as shown in FIG. 4. On the contrary, when tightening the bolt 21 as shown in FIG. 5, the left and right clamps 22, 23 are moved toward each other, the left and right clamping portions 221, 231 are in clamp status to clamp the rails of the seat 50 in the clamp spaces 24. The springs 41, 42 provide a force to push the left and right clamps 22, 23 away from the seat stem 10 when loosing the bolt 21. It is noted that the left and right clamps 22, 23 are slidably connected to each other and this is convenient for the assembler to assemble the seat 5o to the securing device.

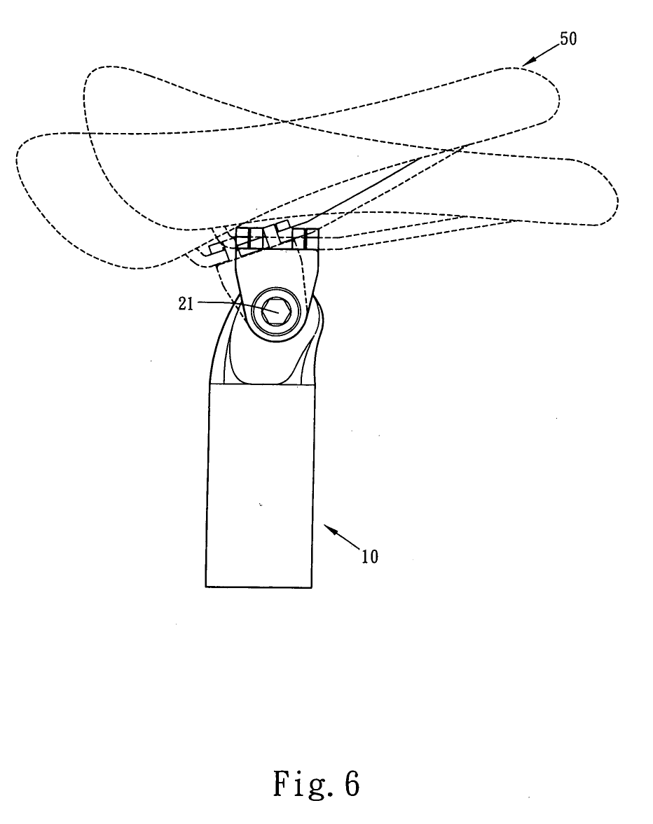

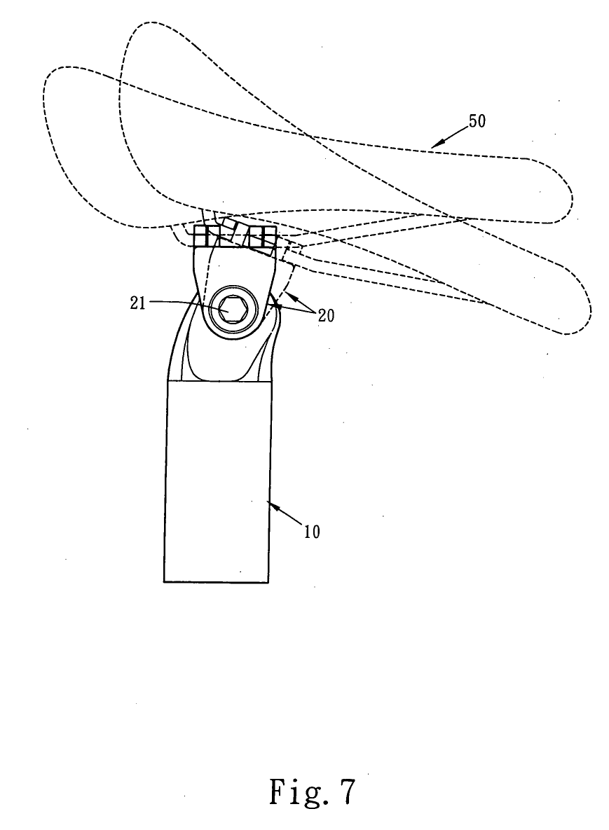

As shown in FIGS. 6 and 7, when slightly loosening the bolt 21, the seat 50 can be pivoted about the bolt 21 to adjust the angle relative to the seat stem 10.

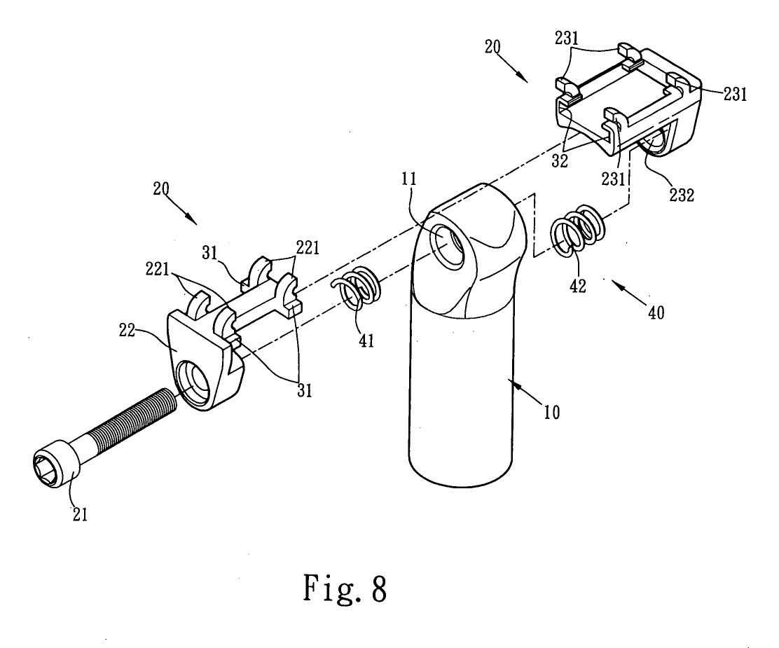

FIG. 8 shows the second embodiment of the securing device of the present invention, wherein the flanges 31 of first engaging portion in the first embodiment are in a form of four blocks extending from two sides of the rectangular board of the left clamp 22 and the grooves 32 of second engaging portion are made by four protrusions.

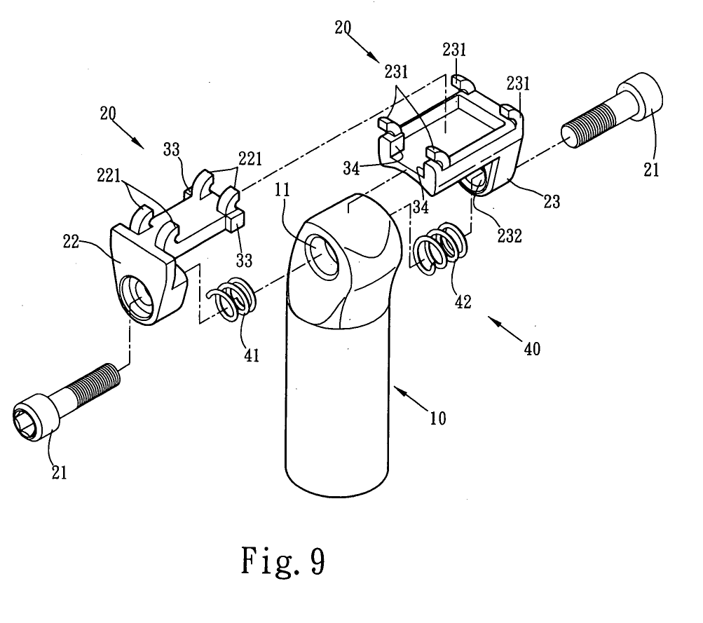

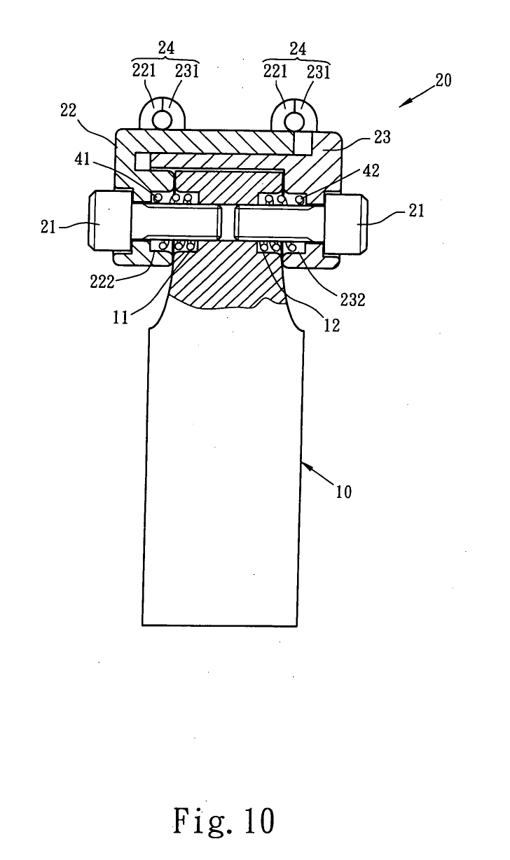

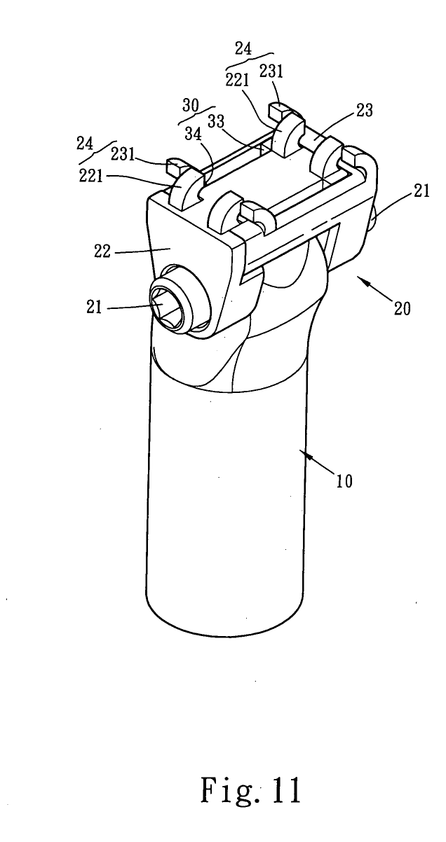

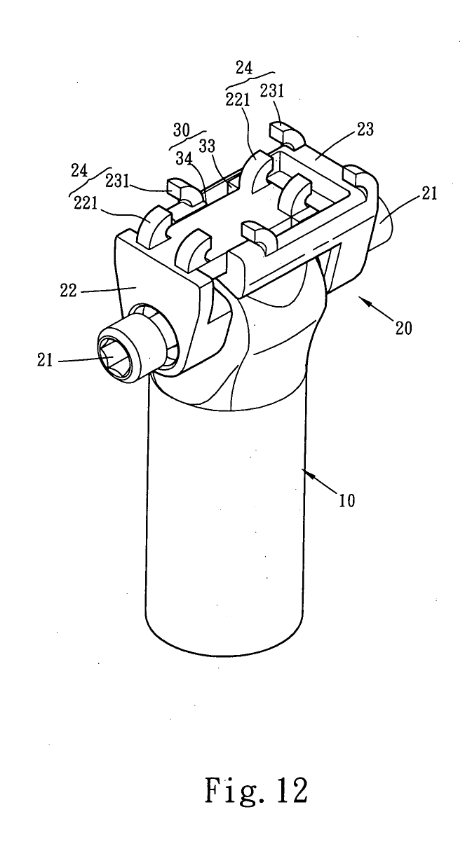

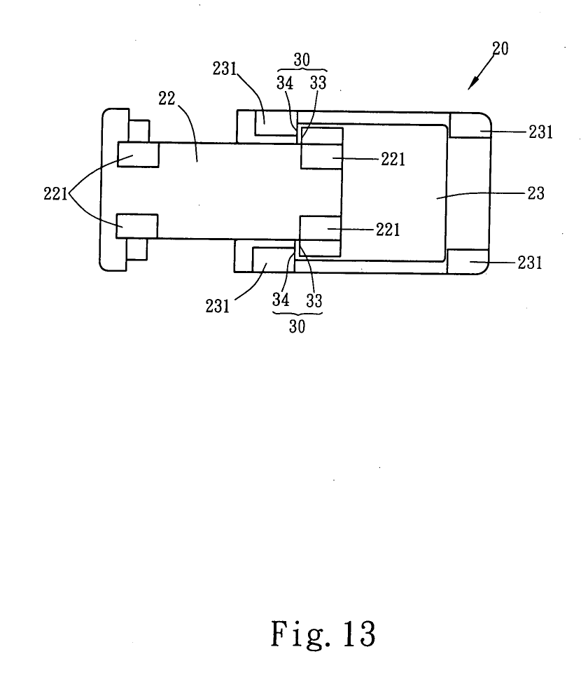

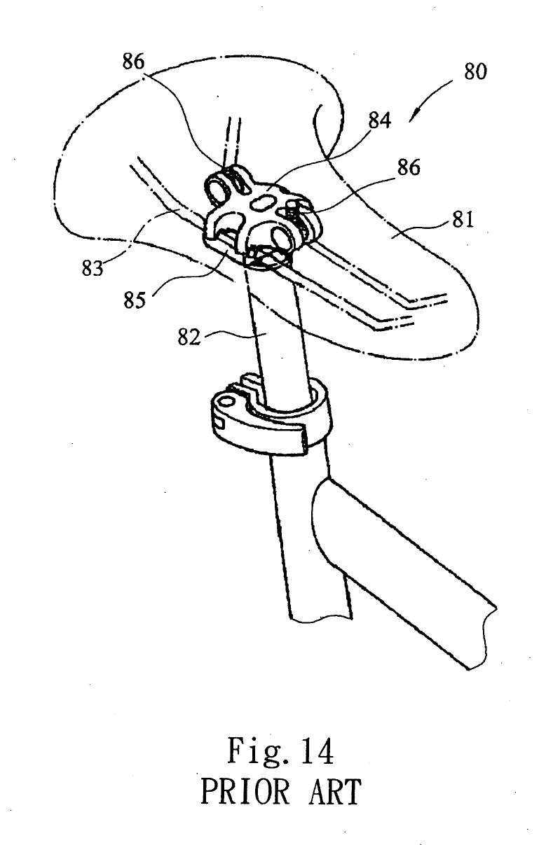

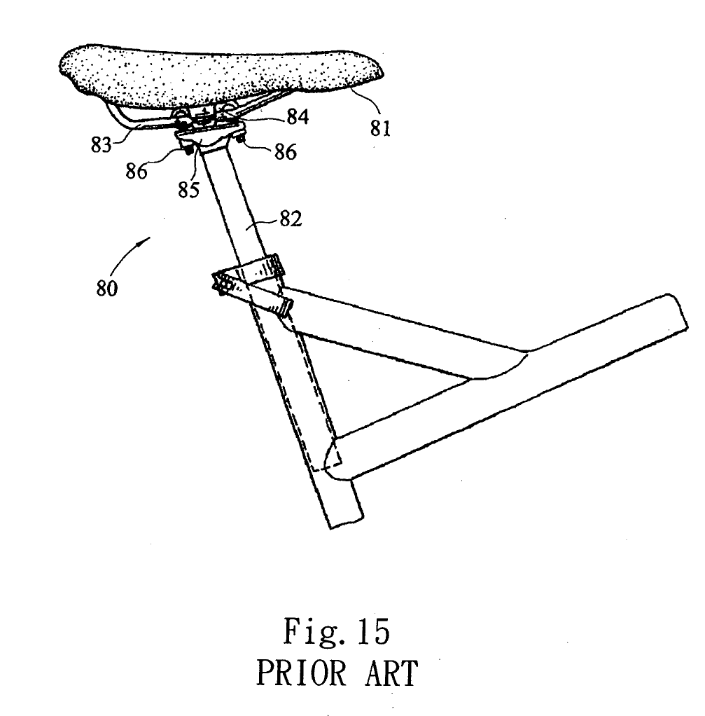

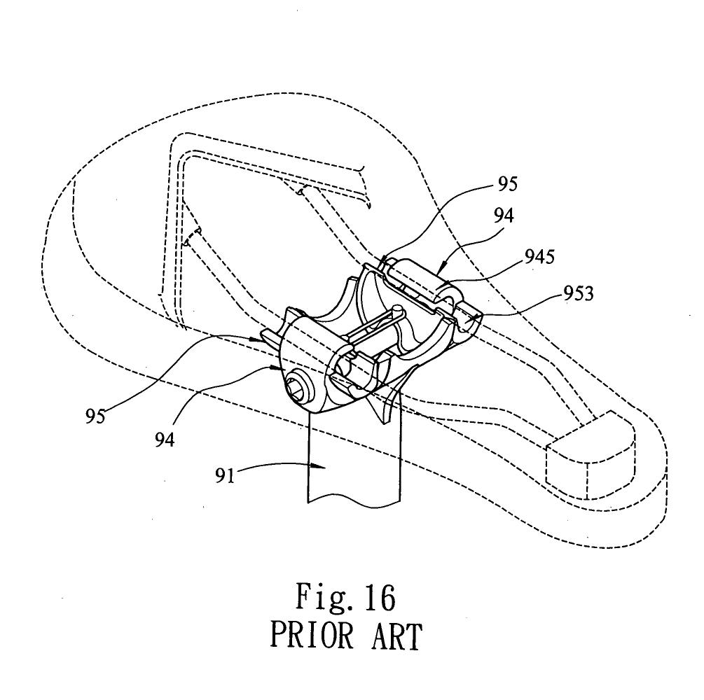

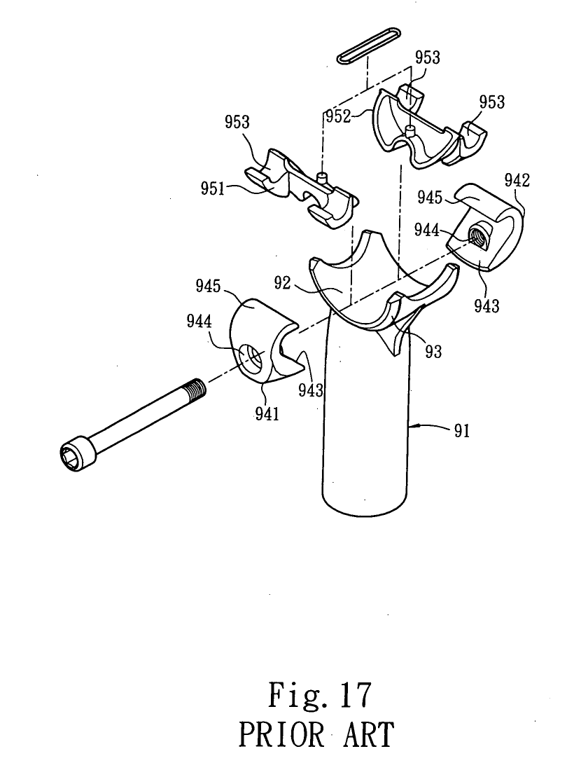

FIGS. 9 to 13 show the third embodiment of the securing device of the present invention, wherein the left clamp 22 and the right clamp 23 are connected to the seat stem 10 by two bolts 21 respectively, and the flanges 31 of first engaging portion in the first embodiment are in a form of two first blocks 33 extending from two sides of the rectangular board of the left clamp 22 and the rectangular board of the left clamp 22 is engaged with a recessed area in a top of the rectangular board of the right clamp 23 from the top of the recessed area, two second blocks 34 extend inward from two insides of the recessed area of the rectangular board of the right clamp 23. The first blocks 33 and the two second blocks 34 extend perpendicularly to the radial direction of the seat stem 10. The rectangular board of the left clamp 22 is slidably engaged with the two insides of the recessed area of the rectangular board of the right clamp 23, and the first blocks 33 are stopped by the second blocks 34 to prevent the first clamp 22 from dropping out from the right clamp 23 when the first clamp 22 and the second clamp 23 are moved away from each other. When the first and second clamps 22, 23 are moved away from each other, the clamping unit 20 is rotatable relative to the seat stem 10. When the first and second clamps 22, 23 are moved toward each other and contact the seat stem 10, the clamping unit 20 is secured to the seat stem 10.

The left and right clamps 22, 23 are connected to the seat stem 10 by the bolt 21 and are slidably connected to each other so that during assembling, the left and right clamps 22, 23 are well positioned to the seat stem 10 without worry of lost. The two springs 41, 42 push the left and right clamps 22, 23 away from each other when the bolt 21 is loosened such that the seat 10 can be quickly and easily to remove from the securing device or to pivot about the bolt 21.

While we have shown and described the embodiment in accordance with the present invention, it should be clear to those skilled in the art that further embodiments may be made without departing from the scope of the present invention.

What is claimed is:

1. A bicycle seat securing device comprising:
a seat stem;
a clamping unit connected to the seat stem along a radial direction of the seat stem 10 and including a left clamp and a right clamp, the seat stem 10 located between the left clamp and the right clamp, the left clamp and the right clamp being moved linearly in the radial direction of the seat stem.

2. The device as claimed in claim 1, wherein the left clamp includes a left clamping portion and the right clamp includes a right clamping portion which are cooperated with the left clamping portion to form a clamp space which is adapted to clamp rails of a seat.

3. The device as claimed in claim 2, wherein the left clamping portion and the right clamp are located along parallel radial planes.

4. The device as claimed in claim 2, wherein the left clamping portion includes four curved hooks and the right clamp includes four curved hooks which face the four curved hooks of the left clamping portion.

5. The device as claimed in claim 2, wherein when the left and right clamps are moved away from each other, the left and right clamping portions are in un-clamp status.

6. The device as claimed in claim 2, wherein when the left and right clamps are moved toward each other, the left and right clamping portions are in clamp status.

7. The device as claimed in claim 1, wherein the clamp unit is connected to the seat stem by a bolt which extends through the clamp unit and the seat stem, the clamp unit is pivotable about the bolt.

8. The device as claimed in claim 1 further comprising an engaging unit which is located between the left and right clamps so as to guide the left and right clamps to move relative each other in the radial direction of the seat stem.

9. The device as claimed in claim 8, wherein the engaging unit includes a first engaging portion connected to the left clamp and a second engaging portion is connected on the right clamp, the first engaging portion is slidably connected with second engaging portion.

10. The device as claimed in claim 9, wherein the first engaging portion includes two flanges on two sides of the left clamp and the second engaging portion includes two grooves defined in the right clamp, the flanges are slidably engaged with the grooves, the flanges extend perpendicularly to the radial direction of the seat stem.

11. The device as claimed in claim 9, wherein the first engaging portion includes two first blocks extending from two sides of the left clamp and the second engaging portion includes two second blocks, the first blocks are stopped by the second blocks.

12. The device as claimed in claim 11, wherein the first blocks and the two second blocks extend perpendicularly to the radial direction of the seat stem, the first blocks are stopped by the second blocks when the first clamp and the second clamp are moved away from each other.

13. The device as claimed in claim 1, wherein when the first and second clamps are moved away from each other, the clamping unit is rotatable relative to the seat stem.

14. The device as claimed in claim 1, wherein when the first and second clamps are moved toward each other and contact the seat stem, the clamping unit is secured to the seat stem.

15. The device as claimed in claim 1 further comprising a spring unit which includes two springs, one of the springs is connected between the left clamp, the seat stem and the other spring is connected between right clamp and the seat stem.

16. The device as claimed in claim 15, wherein the seat stem includes two first recesses in two sides of a head portion thereof and the first and second clamps have two second recess respectively, the two springs are respectively engaged with the first and second recesses.
